(19) United States
(12) Patent Application Publication
(10) Pub. No.: US 2008/0259827 A1
(43) Pub. Date: Oct. 23, 2008

(54) Communication System Using Frequency According to Security or Transmission Distance

(75) Inventors: Jin-Bong Sung, Daejeon-city (KR); Sung Weon Kang, Daejeon-city (KR); Jung Hwan Hwang, Daejeon-city (KR); Duck Gun Park, Daejeon-city (KR); Chang Hee Hyoung, Daejeon-city (KR); Jin Kyung Kim, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 12/096,569

(22) PCT Filed: Dec. 6, 2006
(86) PCT No.: PCT/KR2006/005237

§ 371 Date: Jun. 6, 2008

(30) Foreign Application Priority Data
Dec. 8, 2005 (KR) 10-2005-0120004

(51) Int. Cl. H04J 1/00; H04L 5/14; H04B 7/005; H04B 7/00

(52) U.S. Cl. 370/281; 455/41.2; 455/100; 455/41.1

(57) ABSTRACT

A communication system using a frequency determined according to information security protection or a transmission distance of a signal is provided. A local area communication requiring information security protection uses a frequency less than a predetermined frequency, and a local or wide area communication requiring no information security protection uses a frequency greater than predetermined frequency, thereby providing an effective communication environment based on information security protection, a communication distance, and communication characteristics satisfying frequency characteristics of a transmission medium, and accordingly increasing a communication field.

### TECHNICAL FIELD

The present invention relates to a communication system, and more particularly to, a communication system through a transmission medium in which a sending end and receiving end are adhered.

### BACKGROUND ART

People in modern society always carry personal digital assistants (PDA), cellular phones, medical devices, etc. with themselves. These devices transmit data using wired transmission methods using cables and wireless transmission methods using radio waves and light.

Cable transmission methods provide security protection and high transmission speed but people should always carry cable devices such as cables with themselves. Meanwhile, wireless transmission methods are easy to transmit data but require additional circuits, causing additional manufacturing costs.

To address these problems, human body communication systems using a human body as a transmission medium are introduced. In detail, a transmitter transmits a signal to a transmitting electrode coupled to the human body and a receiver receives the signal from a receiving electrode coupled to the human body. The human body communication systems require no separate wired devices such as cables and no additional circuits necessary for the wireless transmission.

The human body communication systems that use the human body as the transmission medium communicates a single or a plurality of transmitters and receivers located around the human body.

### DISCLOSURE OF INVENTION

### Technical Problem

The human body communication systems prevent the signal from being transmitted to a communication device of another user in order to protect communication security of the transmitters and receivers. If the signal exceeds a specific frequency range, the human body acts as an antenna and thus the signal is radiated to outside the body. Therefore, the human body communication systems cannot realize a high transmission speed due to a low frequency, i.e., when the signal does not exceed the specific frequency range.

### Technical Solution

The present invention provides a communication system that uses a frequency according to security protection or a transmission distance, thereby transmitting a signal through a transmission medium and providing a high transmission speed and security protection.

According to an aspect of the present invention, there is provided a communication system using a frequency determined according to information security protection or a transmission distance of a signal in which a local area communication requiring information security protection uses a frequency less than a predetermined frequency, and a local area communication requiring no information security protection or wide communication uses a frequency greater than the predetermined frequency.

According to another aspect of the present invention, there is provided a communication system using a frequency determined according to information security protection or a transmission distance of a signal, the communication system comprises: a transmitter transmitting the signal having a frequency less than a predetermined frequency in a local area communication requiring information security protection, and a frequency greater than predetermined frequency in a local area communication requiring no information security protection or wide communication; a transmission medium transferring the signal transmitted from the transmitter; and a receiver receiving the signal transferred via the transmission medium.

### DESCRIPTION OF DRAWINGS

The above and other features and advantages of the present invention will become more apparent by describing in detail embodiments thereof with reference to the attached drawings in which:

FIG. 1 is a block diagram of a communication system according to an embodiment of the present invention;

FIG. 2 illustrates a transmitter according to an embodiment of the present invention;

FIG. 3 illustrates a transmitter according to another embodiment of the present invention;

FIGS. 4A through 4E illustrate relationships between communication environments and signal transmission via the communication environments;

FIG. 5 illustrates an application of a communication system according to an embodiment of the present invention;

FIG. 6 illustrates an application of a communication system according to another embodiment of the present invention; and

FIG. 7 illustrates an application of a communication system according to another embodiment of the present invention.

### BEST MODE

The present invention will now be described more fully with reference to the accompanying drawings in which embodiments of the present invention are shown.

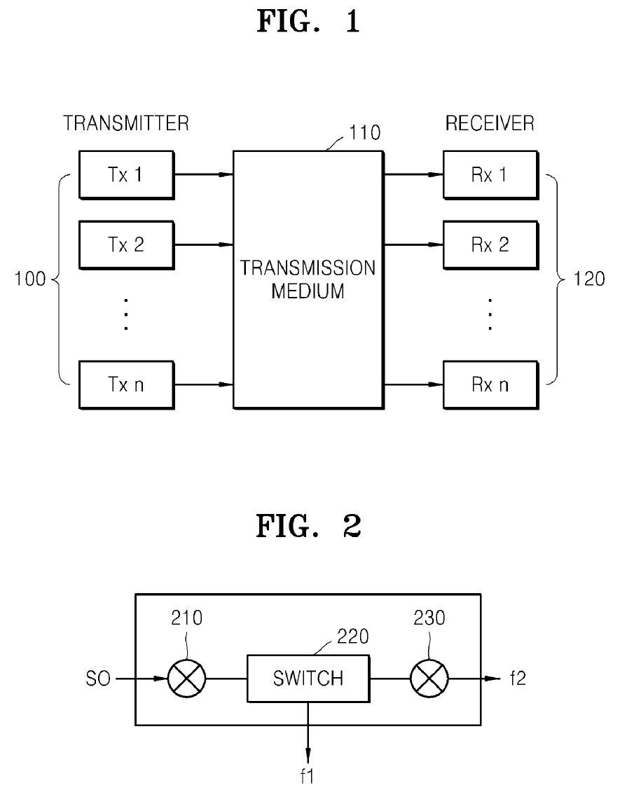

FIG. 1 is a block diagram of a communication system according to an embodiment of the present invention. Referring to FIG. 1, the communication system comprises transmitters 100 Tx 1 through Tx n that transmit a signal using a frequency less than a predetermined frequency for local area communication requiring information security protection and a frequency greater than the predetermined frequency for local area communication requiring no information security protection or wide area communication as a transmission frequency, a transmission medium 110 that transfers the signal from the transmitters 100 Tx 1 through Tx n to receivers 120 Rx 1 through Rx n, and the receivers 120 Rx 1 through Rx n that receive the signal through the transmission medium 110.

That is, the communication system uses the frequency less than the predetermined frequency for local area communication requiring information security protection and the frequency greater than the predetermined frequency for local area communication requiring no information security protection or wide area communication as the transmission frequency.

Each of the transmitter 100 Tx 1 through Tx n comprise a transmission oscillator that generates a predetermined alternating current (AC) signal and a modulator that modulates the information signal using the AC signal to the frequency according to security protection of information data included in a signal to be transmitted and a transmission distance of the signal.

The modulator modulates the information signal to be transmitted using one of an amplitude, frequency, and phase modulation.

Each of the receivers 120 Rx 1 through Rx n comprise a receiving oscillator that generates a predetermined AC signal and a demodulator that demodulates a received signal using the AC signal according to security protection of information data included in the received signal and a transmission distance of the received signal.

The communication system has transmission and receiving functions, causing interference between transmission/receiving signals. Time division duplexing (TDD) or frequency division duplexing (FDD) is used to remove the interference between transmission and receiving signals. To this end, a switch is interposed between the transmitters 100 and the receivers 120 in the TDD, and a duplexer is interposed between the transmitters 100 and the receivers 120 in the FDD.

The communication system further comprises the duplexer that is coupled to the transmitters 100 and the receivers 120 and separates the transmission and receiving signals input/output by the between the transmitters 100 and the receivers 120, and an electrodes that is connected to the transmission medium 110 and the duplexer and transfers the separated transmission and receiving signals. The electrode is tightly adhered to the transmission medium 110 to form a transmission route.

The transmitters 100 and the receivers 120 communicate each other using the FDD.

FIG. 2 illustrates a transmitter according to an embodiment of the present invention. Referring to FIG. 2, the transmitter comprises frequency converters 210 and 230, and a switch 220. The frequency converter 210 converts an information signal S0 including information on a transmission signal into a frequency f1 or the frequency converter 230 converts the information signal S0 into a frequency f2. The information transmission signal having the frequencies f1 or f2 are transmitted through the transmission medium 110 illustrated in FIG. 1.

The frequency f1 is less than a specific frequency and the frequency f2 is greater than the specific frequency based on a specific frequency value. The switch 220 selects the frequency f1 to be used in local area communication requiring information security protection or the frequency f2 to be used in local area communication requiring no information security protection or wide area communication. The switch 220 determines the frequencies f1 or f2 according to security protection and transmission distance of the information signal S0.

The transmitter of the current embodiment of the present invention in FIG. 2 may further comprise an amplifier or a filter a duplexer or a switch that separates the transmitter and a receiver, and control section to control the switch.

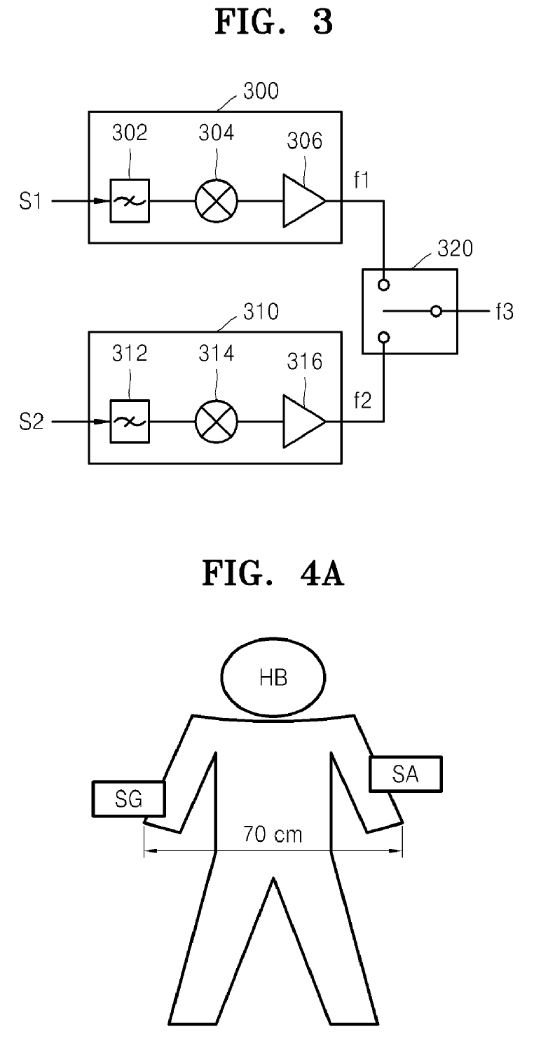

FIG. 3 illustrates a transmitter according to another embodiment of the present invention. Referring to FIG. 3, the transmitter comprises a first frequency converter 300 that outputs a signal having a frequency greater than a predetermined frequency according to security protection of information data included in a transmission signal and a transmission distance of the signal, a second frequency converter 310 that outputs a signal having a frequency less than the predetermined frequency according to the security protection of the information data included in the transmission signal and the transmission distance of the signal, and a switch 320 that switches one of the output by the first and second frequency converters 300 and 310.

In detail, the transmitter of the current embodiment of the present invention uses one of the first frequency converter 300 and the second frequency converter 310 according to an output frequency, information type, or a transmission distance of the signal.

The transmitter uses the first frequency converter 300 to output a signal including S1 information having the frequency f1 less than a specific frequency, and the second frequency converter 310 to output a signal including S2 information having the frequency f2 greater than the specific frequency.

A filter 302 filers the signal S1 to remove noise, a frequency converter 304 converts the filtered signal into the frequency f1, and an amplifier 306 amplifies the converted signal. Likewise, a filter 312 filers the signal, a frequency converter 314 converts the filtered signal S2 into the frequency f2, and an amplifier 316 amplifies the converted signal.

The switch 320 finally selects the output frequency that are converted by the first frequency converter 300 and the second frequency converter 310. The switch 320 selects the signal S1 or S2 according to a frequency based on information type and distance of the signal S1 or S2 and determines the signal S1 or S2 to be transmitted to a transmission medium.

The transmitter of the current embodiment of the present invention in FIG. 2 may further comprise an amplifier or a filter, and a duplexer or a switch that separates the transmitter and a receiver.

The communication system illustrated in FIG. 1 uses a dielectric living body as the transmission medium 110. The dielectric living body can be a human body.

In view of transfer characteristics according to a distance between a transmitter and receiver around the human body, a signal having a low frequency is mainly transmitted within a human body medium since the human body serves as a wired transmission route. To this end, the human body is directly connected to the transmitter or the receiver.

If a near field forms around the human body and an electrode is interposed between the transmitter and receiver within the near field, a signal having a predetermined frequency can be transmitted through the human body medium even though the human body is not directly connected to the electrode.

Meanwhile, since a signal having a high frequency is radiated outside the human body, and transmission loss is not serous even when the human body is far away, the signal can be transmitted to a local area and wide area. Most of all, the signal having the high frequency can realize a higher transmission speed than the signal having the low frequency.

Therefore, a signal frequency is determined according to information security protection and transmission distance of a transmission signal, thereby enabling effective communication.

A local area communication requiring information security protection, which does not allow a signal to be transmitted outside the human body, uses the human body transmission route or near field and thus selects a signal having a frequency less than a specific frequency. Also, a local area communication requires no information security or a wide area communication, which allows or requires a signal to be transmitted outside the human body, selects a signal having a frequency greater than the specific frequency.

The local area communication selects a frequency according to whether security protection is required. The specific frequency depends on a magnitude of a signal output by the transmitter, sensitivity of the receiver, characteristics of a transmission medium between the transmitter and the receiver, characteristic or shape of the electrode interposed between the transmitter and the receiver, etc.

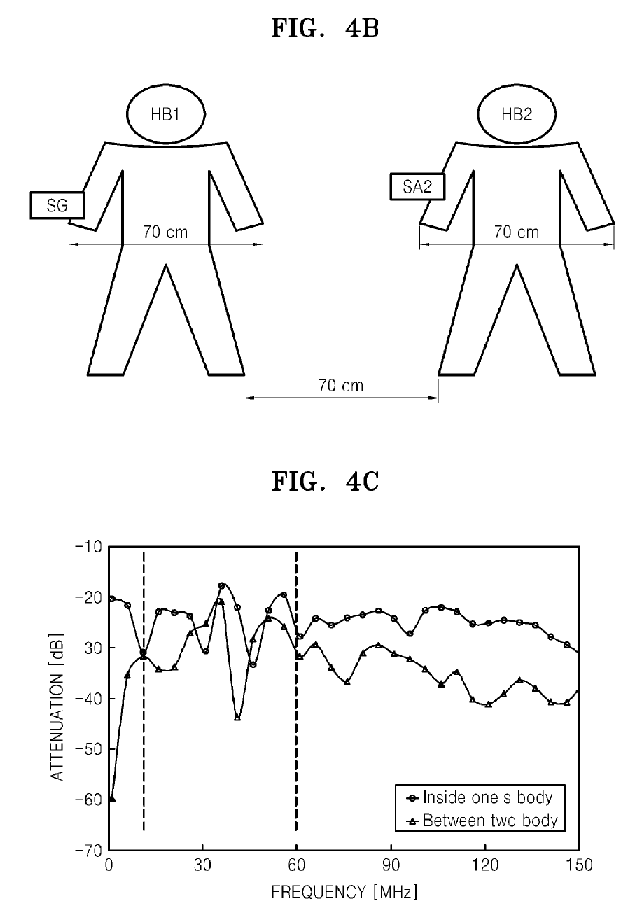

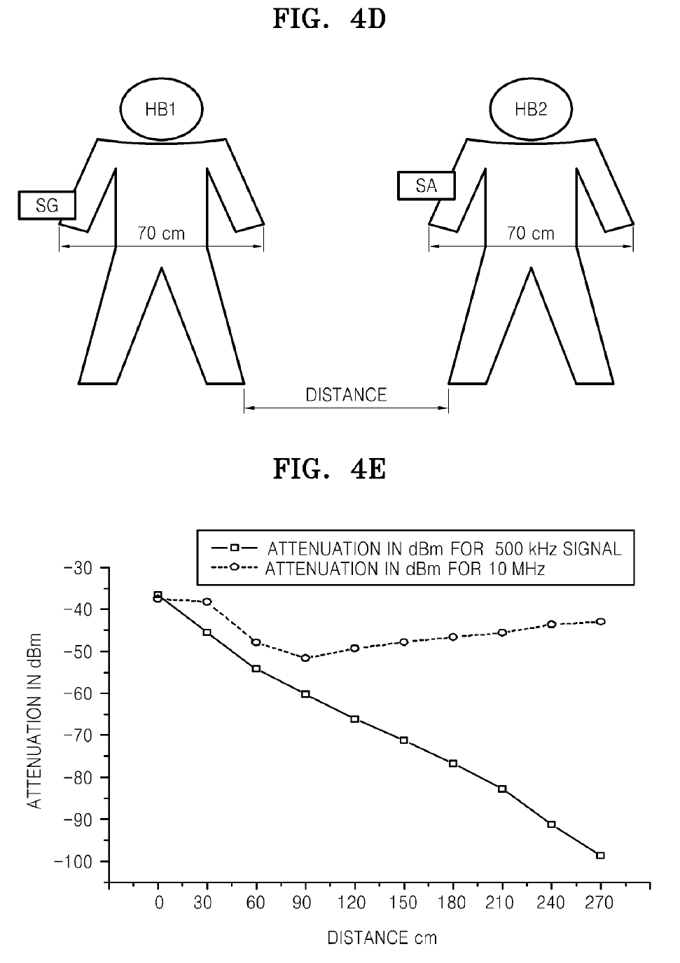

FIGS. 4A through 4E illustrate signal transmission characteristics of the human body as a transmission medium. Referring to FIG. 4A, a crystal oscillator (SG) that generates a signal is connected to an arm of a first human body (HB) and a signal analyzer (SA) that measures the signal transmitted via the first HB is connected to the other arm of the HB. A distance between two arms is about 70 cm. Referring to FIG. 4B, a device for generating (SG) and analyzing (SA2) a signal is connected to an arm of a second HB that is away about 70 cm from the first HB in order to understand characteristics of the signal to be radiated outside the first HB.

A result obtained by measuring the signal is presented in a graph illustrated in FIG. 4C. The y-axis denotes the difference between signal generator (SG) and signal analyzer (SA1, SA2). The graph shows that the magnitude of the signal transmitted after being radiated outside the second HB is below −35 dB when the transmission/reception signal has a frequency of 0 MHz through 10 MHz. However, the magnitude of the signal transmitted within the first HB is relatively similar to that of the signal transmitted after being radiated outside the first HB when the transmission/reception signal has a frequency of 10 MHz through 60 MHz. The magnitude of the signal transmitted after being radiated outside the first HB is greater than that of the signal transmitted within the first HB when the transmission/reception signal has a frequency more than 60 MHz.

Referring to FIG. 4D, to understand signal transmission characteristics according to a distance between the first and second HBs, a SG that generates a signal is connected to an arm of the first HB, and a SA that measures the signal that is radiated from the first HB and is transmitted to the second HB is connected to an arm of the second HB.

The magnitude of a SG output signal is 0 dBm and output frequencies thereof are 500 KHz and 10 MHz. The distance between the first and second HBs is 0 cm when both HBs are hand in hand and is increased by 30 cm to measure the magnitude of the signal.

Referring to FIG. 4E, a graph shows the magnitude of the output signal by the SA. The magnitude of the signal having 500 kHz is rapidly reduced as the distance increases, whereas the magnitude of the signal having 10 MHz remains unchanged regardless of variance of the distance.

When the transmission/reception signal has a frequency below 10 MHz, the magnitude of the signal that is radiated from the first HB and is transmitted to the second HB is very small. Therefore, the frequency of 10 MHz provides superior security protection to a human body communication unless another human body accesses near the HB. When the transmission/reception signal has a frequency higher than 10 MHz, the signal that is radiated from the first HB and is transmitted to the second HB has the greater magnitude than the signal that is transmitted within the HB, and has a constant transmission loss regardless of a distance from another human body within a predetermined range.

In detail, the human body communication using the human body transmission route or the near field uses a frequency below 10 MHz uses, whereas the local or wide area communication in which a signal can be transmitted outside the human body and to a communication device carried by another user uses a frequency greater than 10 MHz. In this case, the frequency of 10 MHz is set to a specific frequency or a predetermined frequency.

For a simple application, an interference-free communication can be performed between two transmission frequencies higher and lower than the specific frequency if the two transmission frequencies substantially differ from each other. For example, a frequency lower than the specific frequency is used to authenticate personal identification necessary for a cash service, and a frequency higher than the specific frequency is used to listen to a radio.

Since a plurality of transmitters and receivers accordingly require a lot of high and low frequencies, a communication system must use one of multiple accessing such as frequency division multiple access (FDMA), time division multiple access (TDMA), code division multiple access (CDMA), and orthogonal frequency division multiplex (OFDM), or a combination thereof. That is, the multiple access communication system can simultaneously transmit at least two signals with making the two transmission frequencies not much different from each other.

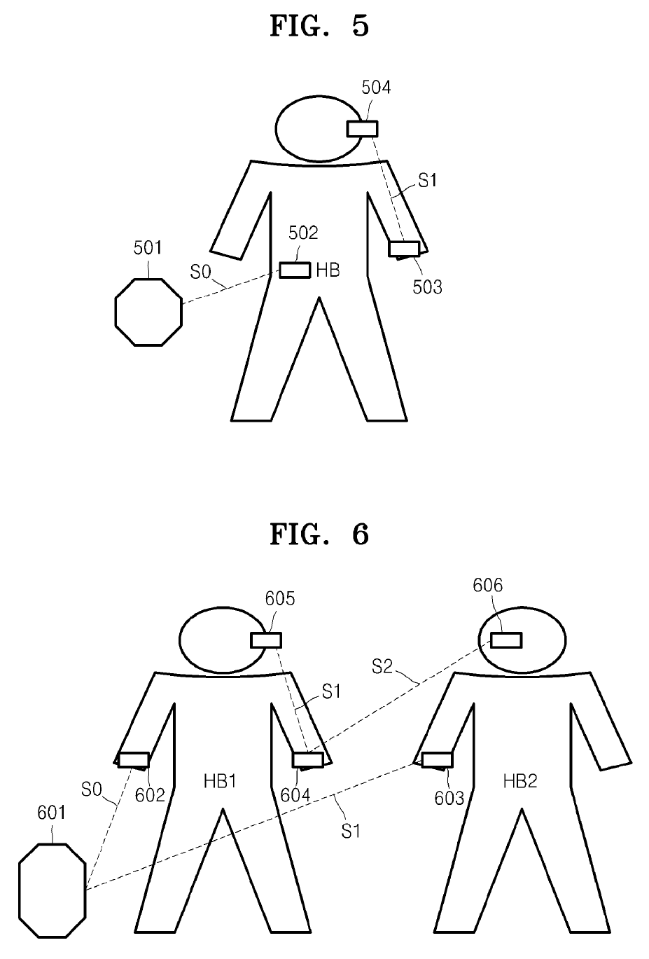

FIG. 5 illustrates an application of a communication system according to an embodiment of the present invention. Referring to FIG. 5, a HB that carries an authentication device 502, a music player 503, and a headphone 504 with the HB can listen to music S1 output by the music player 503 from the headphone 504. The music player 503 serves as a transmitter, the HB serves as a transmission medium, and the headphone 504 serves as a receiver. Since the communication system uses a local area communication, the music S1 is transmitted over a frequency less than a specific frequency.

The communication system of the current embodiment of the present invention can send personal information S0 stored in the authentication device 502 to an authenticator 501 through a body touch while the HB listens to the music S1. If the HB touches his hand to the authenticator 501, the authentication device 502 serving as the transmitter transmits the personal information S0 to the authenticator 501 serving as the receiver through his hand serving as the transmission medium that touched the authenticator 501. The authentication device 502 transmits the personal information S0 to the authenticator 502 through the HB serving as the transmission medium if the HB's hand touches the authenticator 501 to form a contact point or the authenticator 502 is located in a near field through the HB's hand.

Since the personal information S0 requires security protection, a transmission frequency of the personal information S0 is less than the specific frequency. Since the music S1 is prevented from other users listening to music using the same communication system and thus requires security protection, a transmission frequency of the music S1 is less than the specific frequency.

The two signals S0 and S1 are simultaneously transmitted in the HB. In this case, multiple accessing using a different code or frequency is used to avoid interference between the two signals S0 and S1.

FIG. 6 illustrates an application of a communication system according to another embodiment of the present invention. Referring to FIG. 6, a first HB and a second HB transmit two pieces of information S0 and S1 necessary for identifying the first and second HBs and pay charges for an amusement park using authentication devices 602 and 603 carried by the first and second HBs' wrists, respectively, to an authenticator 601. The information S0 and S1 require security protection and thus a transmission frequency is less than a specific frequency. In this case, multiple accessing is used to transmit the information S0 and S1 in order to avoid interference between the information S0 and S1.

A device 604 serving as a camera carried by the first HB takes a photo and transmits photo data S2 to displayers 605 and 606 carried by the first and second HBs. The device 604 transmits the photo data S2 to the displayer 605 carried by the first HB via inside the first HB, which is a local area transmission. Therefore, a transmission frequency of the photo data S2 can be less than the specific frequency. However, since the photo data S2 does not require security protection, the transmission frequency of the photo data S2 can be greater than the specific frequency.

The device 604 transmits the photo data S2 to the displayer 606 carried by the second HB via outside the first HB. Therefore, a transmission frequency of the photo data S2 can be greater than the specific frequency. In this regard, the device serves as a transmitter, the displayer 606 serves as a receiver, and the first HB serves as a transmission medium.

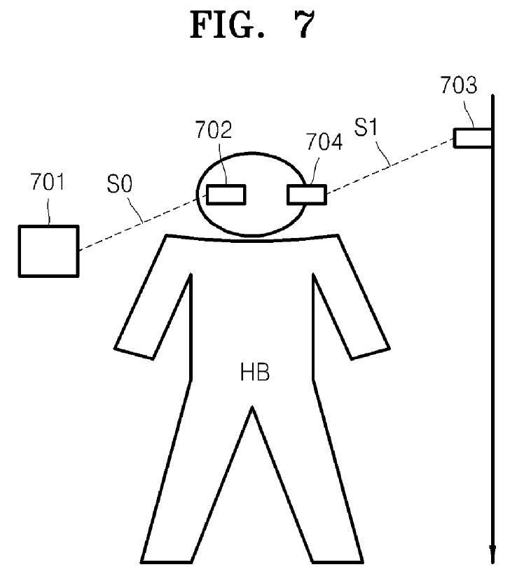

FIG. 7 illustrates an application of a communication system according to another embodiment of the present invention. Referring to FIG. 7, if a HB touches a product 701 at a shopping mall, a displayer 702 carried by the HB displays product information S0 such as a price, an expiry date, etc. The product 701 includes a first transmitter according to the present invention, and transmits the product information S0 to the displayer 702 serving as a receiver via the HB serving as a transmission medium. The HB hears announcement S1 of the shopping mall transmitted from a speaker 703 serving as a second transmitter via a headset 704.

Since the product information S0 can require security protection, a transmission frequency of the product information S0 is less than the specific frequency. Also, since all customers in the shopping mall must hear the announcement S1, a transmission frequency of the announcement S1 is greater than the specific frequency.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a local area communication requiring information security protection uses a frequency less than a predetermined frequency. A local or wide area communication requiring no information security protection uses a frequency greater than predetermined frequency. Therefore, the present invention can provide an effective communication environment based on information security protection, a communication distance, and communication characteristics satisfying frequency characteristics of a transmission medium, thereby increasing a communication field.

The present invention provides a communication system and method that selects a communication frequency satisfying an application service based on the communication distance and transmission speed in an environment where at least one transmitter, at least one receiver, and at least one conductive transmission medium are connected in a human body.

1. A communication system using a frequency determined according to information security protection or a transmission distance of a signal in which a local area communication requiring information security protection uses a frequency less than a predetermined frequency, and a local area communication requiring no information security protection or wide communication uses a frequency greater than the predetermined frequency.

2. The communication system of claim 1, comprising:
a transmitter transmitting the signal of the frequency determined according to the information security protection, or the local or wide area communication; and
a transmission medium transferring the signal transmitted from the transmitter.

3. The communication system of claim 2, wherein the transmitter comprises:
a transmission oscillator generating a predetermined alternating current (AC) signal; and
a modulator modulating the information data using the AC signal to a frequency determined according to whether information data included in the transmitted signal is secured and a transmission distance of the transmitted signal.

4. The communication system of claim 2, further comprising: a receiver receiving the signal of the frequency determined according to the information security protection, or the local or wide area communication.

5. The communication system of claim 4, wherein the receiver comprises:
a receiving oscillator generating a predetermined AC signal; and
a demodulator demodulating the received signal using the AC signal according to whether information data included in the received signal is secured and a transmission distance of the received signal.

6. The communication system of claim 4, further comprising:
a duplexer connected to the transmitter and receiver, and separating transmission/receiving signals input/output by the transmitter and receiver; and
an electrode connected between the transmission medium and the duplexer and transferring the separated transmission/receiving signals.

7. The communication system of claim 4, wherein the transmitter and receiver communicate each other using frequency division duplex.

8. The communication system of claim 4, wherein, if the communication system includes a plurality of transmitters and receivers, the plurality of transmitters and receivers use one of multiple accessing such as frequency division multiple access (FDMA), time division multiple access (TDMA), code division multiple access (CDMA), and orthogonal frequency division multiplex (OFDM), or a combination thereof.

9. The communication system of claim 3, wherein the transmitter further comprises:
a first frequency converter outputting a signal having the frequency greater than the predetermined frequency according to whether information data included in the transmitted signal is secured and a transmission distance of the transmitted signal;
a second frequency converter outputting a signal having the frequency less than the predetermined frequency according to whether information data included in the transmitted signal is secured and a transmission distance of the transmitted signal; and
a switch selecting one of signals output by the first and second frequency converters and outputting the selected signal.

10. The communication system of claim 4, wherein the receiver comprises: a frequency converter controlling a frequency of the received signal.

11. The communication system of claim 1, wherein the predetermined frequency is substantially 10 MHz.

12. The communication system of claim 2, wherein the transmission medium is a living body.

13. The communication system of claim 12, wherein the transmission medium is a human body.

14. A communication system using a frequency determined according to information security protection or a transmission distance of a signal, the communication system comprises:
a transmitter transmitting the signal having a frequency less than a predetermined frequency in a local area communication requiring information security protection, and a frequency greater than predetermined frequency in a local area communication requiring no information security protection or wide communication;
a transmission medium transferring the signal transmitted from the transmitter; and
a receiver receiving the signal transmitted via the transmission medium.

15. The communication system of claim 14, wherein the transmitter comprises:
a oscillator generating a predetermined alternating current (AC) signal; and
a modulator modulating the information data using the AC signal to a frequency determined according to whether information data included in the transmitted signal is secured and a transmission distance of the transmitted signal.

16. The communication system of claim 15, wherein the modulator modulates the signal using one of amplitude, frequency, and phase modulation.

17. The communication system of claim 14, wherein the receiver comprises:
a oscillator generating a predetermined AC signal; and
a demodulator demodulating the received signal using the AC signal.

18. The communication system of claim 14, further comprising:
a duplexer connected to the transmitter and receiver, and separating transmission/receiving signals input/output by the transmitter and receiver; and
an electrode connected between the transmission medium and the duplexer and transferring the separated transmission/receiving signals.

19. The communication system of claim 14, wherein the transmitter and receiver communicate each other using frequency division duplex.

20. The communication system of claim 14, wherein, if the communication system includes a plurality of transmitters and receivers, the plurality of transmitters and receivers use one of multiple accessing such as FDMA, TDMA, CDMA, and OFDM, or a combination thereof.

21. The communication system of claim 14, wherein the transmitter further comprises:
a first frequency converter outputting a signal having the frequency greater than the predetermined frequency according to whether information data included in the transmitted signal is secured and a transmission distance of the transmitted signal;
a second frequency converter outputting a signal having the frequency less than the predetermined frequency according to whether information data included in the transmitted signal is secured and a transmission distance of the transmitted signal; and
a switch selecting one of signals output by the first and second frequency converters and outputting the selected signal.

22. The communication system of claim 14, wherein the receiver comprises: a frequency converter controlling a frequency of the received signal.

23. The communication system of claim 14, wherein the predetermined frequency is substantially 10 MHz.

24. The communication system of claim 14, wherein the transmission medium is a living body.

25. The communication system of claim 24, wherein the transmission medium is a human body.
